(19) United States
(12) Patent Application Publication
(10) Pub. No.: US 2008/0246614 A1
(43) Pub. Date: Oct. 9, 2008

(54) RADIO FREQUENCY IDENTIFICATION TAGS

(75) Inventor: Heikki Sakari Paananen, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/695,680

(22) Filed: Apr. 3, 2007

(51) Int. Cl. G08B 13/14

(52) U.S. Cl. 340/572.7

(57) ABSTRACT

A radio frequency identification tag comprising first and second antenna elements, wherein the first and second antenna elements are configurable to be, in use, positioned to lie in substantially different planes.

The present invention relates to the field of radio frequency identification (RFID) tags and associated apparatus and methods. The tags may be so-called active or passive RFID tags.

### BACKGROUND

The most common type of RFID tags are so-called “inlay tags”, which comprise a very thin sheet containing a coil (which acts as an antenna element) and RFID chip (FIG. 1). Data can be read from the inlay tag 10 using a reader 20 (FIG. 2). However, such tags are not readable from all directions and often have a Hestnes factor (the ratio between front reading distance and side reading distance) which is very high.

To address this shortcoming, it is possible to use several reader antennas located in such a way that the tag antenna is always facing towards one reader antenna. Omnidirectional (i.e. cable of receiving energy from all directions) antenna tags can also be used.

The listing or discussion of a prior-published document in this specification should not necessarily be taken as an acknowledgement that the document is part of the state of the art or is common general knowledge.

### SUMMARY

In a first aspect, the present invention provides a radio frequency identification tag comprising first and second antenna elements, wherein the first and second antenna elements are configurable to be, in use, positioned to lie in substantially different planes.

The tag may be arranged such that the antenna elements are configurable to lie in substantially orthogonal planes.

The tag may be arranged to have a first non-use configuration in which the antenna elements are positioned to lie substantially in the same plane, and a second in-use configuration in which the antenna elements are positioned to lie in substantially different planes, and wherein the tag is arranged to be configurable between the first and second configurations.

The tag may comprise fold/crease lines to allow the antenna elements to be configured between one or more first and one or more second tag configurations.

The crease/fold lines may be configured to allow the antenna elements to be repeatedly folded between one or more first and one or more second tag configurations.

The tag may comprise a third antenna element configurable to be positioned to lie in a substantially different plane to the first and second antenna elements.

The third antenna element may be configurable to be positioned to lie in a plane substantially orthogonal to the first and second antenna elements.

The third antenna element may be configurable to be positioned to lie in a plane substantially orthogonal to the first and second antenna elements, the first and second antenna elements configurable to lie in substantially orthogonal planes with respect to one another.

The tag may be arranged to be configurable such that the respective antenna elements are positionable on different faces of the article to which the tag is to be attached, the faces lying in substantially different planes.

The tag may be arranged to be configurable such that the respective antenna elements are positionable around a corner of the article to which the tag is to be attached.

The tag may comprise (e.g. repeatedly) foldable wings, and wherein the first and second antenna elements may each be arranged to be located with (e.g. on or in) a respective foldable wing.

The tag may comprise a body and foldable wings, the body comprising processing circuitry for one or more of the antenna elements, and wherein the first and second antenna elements are each arranged to be located with a respective foldable wing.

The tag may be arranged to comprise processing circuitry for each of the respective antenna elements.

The tag may be arranged to comprise common processing circuitry for the first and second antenna elements.

The tag may be an active tag arranged to comprise its own power supply to provide power to tag processing circuitry.

The tag may be a passive tag arranged to use one or more of the antenna elements to generate power for tag processing circuitry.

The tag may comprise one or more attachments elements (including adhesives) to allow it to be permanently/removably attached to an article.

The tag may be arranged to be attached to an interior or exterior part of the article, or be integrated within respective walls of the article.

The tag may be arranged such that the respective antenna elements can move with respect to one another as the respective faces of the article to which they are attached move with respect to one another.

One or more of the tag antenna elements may be omnidirectional antenna elements.

Processing circuitry may be integrated with the tag or be attachable to the antenna elements to operatively form the tag. The processing circuitry may be located on a wing.

According to second aspect, the present invention provides a tag configured in the first non-use configuration.

According to third aspect, the present invention provides a tag configured in the second in-use configuration.

According to a fourth aspect, the present invention provides a radio frequency identification tag comprising first and second antenna elements, wherein the first and second antenna elements are positioned to lie in substantially different planes.

The tag may be arranged such that the antenna elements are configured to lie in substantially orthogonal planes.

The tag may comprise a third antenna element configured to be positioned to lie in a substantially different plane to the first and second antenna elements.

The third antenna element may be configured to be positioned to lie in a plane substantially orthogonal to the first and second antenna elements.

The third antenna element may be configured to be positioned to lie in a plane substantially orthogonal to the first and second antenna elements, the first and second antenna elements being configured to lie in substantially orthogonal planes with respect to one another.

The tag may be arranged such that the respective antenna elements are positionable on different faces of the article to which it is to be attached, the faces lying in substantially different planes.

The tag may be arranged to be configured such that the respective antenna elements are positionable around a corner of the article to which it is to be attached.

The tag may comprise wings, and two or more of the antenna elements may each be arranged to be located with (e.g. on or in) a respective wing.

The tag may comprise a body and wings, the body comprising processing circuitry for one or more of the antenna elements, and wherein first and second antenna elements are each arranged to be located with a respective wing.

The tag may be arranged to comprise processing circuitry for each of the respective antenna elements.

The tag may be arranged to comprise common processing circuitry for at least two of the antenna elements.

The tag may be an active tag arranged to comprise its own power supply to provide power to tag processing circuitry.

The tag may be a passive tag arranged to use one or more of the antenna elements to generate power for tag processing circuitry.

The tag may comprise one or more attachment elements to allow it to be attached to an article.

The tag may be arranged such that the respective antenna elements can move with respect to one another as the respective faces of the article to which they are attached move with respect to one another.

According to a fifth aspect, the present invention provides an article to which a radio frequency identification tag is attached, the tag comprising antenna elements attached to lie in substantially different planes of the article.

The antenna elements may be attached to lie on substantially orthogonal planes.

According to a sixth aspect, the present invention provides an article to which is attached respective radio frequency identification tags located on two or more faces of the article, the faces lying in substantially different planes.

The article may comprise faces in substantially orthogonal planes, and the respective radio frequency identification tags may be located on respective orthogonal faces.

The article may comprise faces in substantially orthogonal planes, and the respective radio frequency identification tags may be located on all respective orthogonal faces.

According to a seventh aspect, the present invention provides an article comprising a radio frequency identification tag integrated within respective walls of the article, the tag comprising antenna elements arranged to lie in substantially different planes.

According to an eight aspect, the present invention provides an article blank to be formed into an article, the blank comprising portions foldable with respect to one another to form walls of the article which, when the article is formed, lie in substantially different planes, and wherein respective walls comprise antenna elements for one or more radio frequency identification tags.

The blank may be arranged such that the blank comprises crease/fold lines to allow the portions to be folded with respect to one another, the antenna elements forming part of a single radio frequency identification tag.

The single radio frequency identification tag may comprise crease/fold lines co-incident with the crease/fold lines of the blank to allow the respective antenna elements to be folded with the portions to form the walls of the article.

One or more of the walls may be an interior or exterior wall of the formed article.

The article blank may be a blank to be formed into a container. The container may be a packaging container.

The article blank may be a blank to be formed into the outer casing of an electronic device.

A method of reading a radio frequency identification tag using a tag/article according to the present invention.

A method of determining the orientation of a radio frequency identification tag using a tag/article according to the present invention.

A method of determining the orientation of a radio frequency identification tag by measuring the relative field strength of signals received from respective antenna elements using a tag/article according to the present invention.

A method of determining the orientation of a radio frequency identification tag by measuring the relative field strength of signals received from respective antenna elements using a an unsymmetrical tag/article according to the present invention.

The present invention includes one or more aspects, embodiments or features in isolation or in various combinations whether or not specifically stated (including claimed) in that combination or in isolation.

The above summary is intended to be merely exemplary and non-limiting.

### BRIEF DESCRIPTION OF THE DRAWINGS

A description is now given, by way of example only, with reference to the accompanying drawings, in which:-

FIG. 1 shows an inlay RFID tag;

FIG. 2 shows an RFID reader;

FIG. 3 shows an RFID tag according to the invention in an in-use configuration;

FIG. 4 shows the RFID tag of FIG. 3 in more detail and in a non-use configuration;

FIG. 5 illustrates an application of the RFID tag of FIG. 3;

FIG. 6 shows examples of waveforms used in an application of the RFID tag of FIG. 3;

FIG. 7A shows processing circuitry according to one embodiment of the invention;

FIG. 7B shows processing circuitry according to another embodiment of the invention;

FIG. 8 shows processing circuitry according to another embodiment of the invention;

FIG. 9 shows an RFID tag according to another embodiment of the invention;

FIG. 10A shows an article incorporating an RFID tag according to the invention in one arrangement;

FIG. 10B shows an article incorporating an RFID tag according to the invention in another arrangement;

FIG. 10C shows an article incorporating an RFID tag according to the invention in another arrangement;

FIG. 11 shows an RFID tag according to another embodiment of the invention;

FIG. 12 shows an RFID tag according to another embodiment of the invention;

FIG. 13 shows a blank for an article incorporating an RFID tag according to the invention;

FIG. 14 shows an RFID tag according to another embodiment of the invention;

FIG. 15 is a flowchart representing a method according to the invention;

FIGS. 16 and 17 show further embodiments of the present invention.

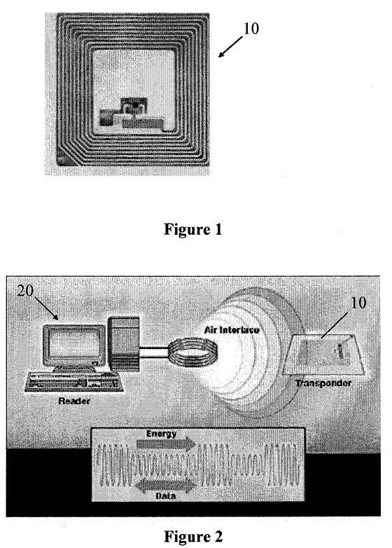

### DETAILED DESCRIPTION

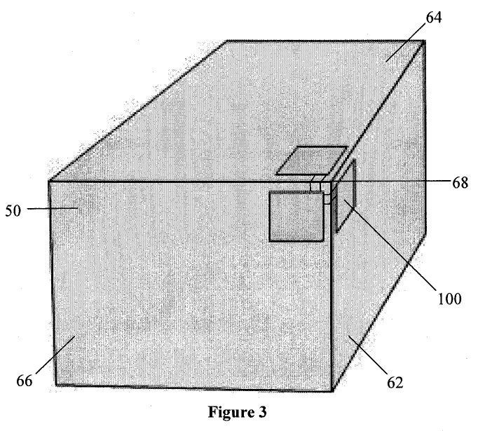

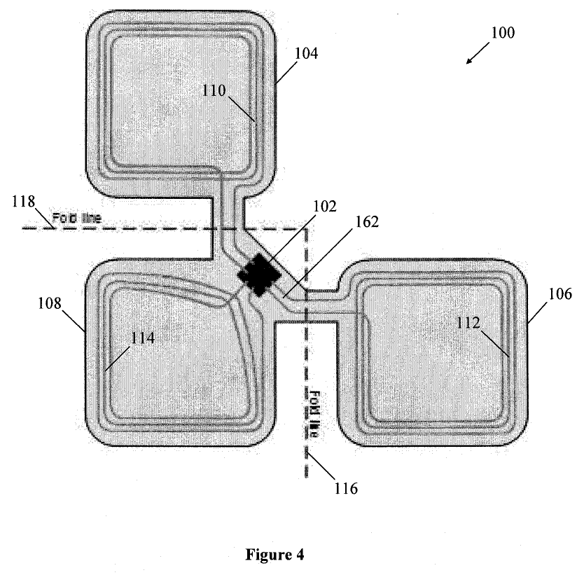

FIG. 3 shows a configurable radio frequency identification (RFID) tag 100 according to the invention in an in-use configuration, attached to an article 50. FIG. 4 shows the RFID tag 100 in more detail and in a non-use configuration.

The RFID tag 100 comprises first, second and third antenna elements 110, 112, 114.

The tag 100 is arranged to have a first, non-use configuration, shown in FIG. 4, in which the antenna elements 110-114 are positioned to lie substantially in the same plane, and a second in-use configuration, shown in FIG. 3, in which the antenna elements 110-114 are positioned to lie in different, substantially mutually-orthogonal planes. The tag 100 is arranged to be configurable between the first and second configurations.

The tag 100 comprises fold/crease lines 116, 118 (shown in FIG. 4) to allow the antenna elements 110-114 to be configured between one or more first and one or more second tag configurations. The fold/crease lines 116, 118 are configured to allow the antenna elements 110-114 to be repeatedly folded between the one or more first and the one or more second tag configurations.

As seen in FIG. 3, the tag 100 is arranged to be configurable such that the respective antenna elements 110-114 are positionable on different faces 62, 64, 66 of the article 50 to which the tag 100 is to be attached, the faces 62-66 lying in different, mutually-orthogonal planes. The tag 100 is arranged to be configurable such that the respective antenna elements 110-114 are positionable around a corner 68 of the article 50 to which the tag 100 is to be attached. The tag 100 is arranged such that the respective antenna elements 110-114 can move with respect to one another as the respective faces 62-66 of the article 50 to which they are attached move with respect to one another.

The tag 100 comprises repeatedly-foldable wings 104, 106, 108, shown in FIG. 4, wherein the first, second and third antenna elements 110-114 are arranged to be located with (e.g. on or in) a respective foldable wing 104-108.

The tag 100 comprises a body 162, the body 162 comprising processing circuitry 102 for one or more of the antenna elements 110-1 14. In one embodiment, as shown in FIG. 7A, the tag 100 is arranged to comprise common processing circuitry 134 for the antenna elements 110-1 14. In another embodiment, as shown in FIG. 7B, the tag 100 is arranged to comprise processing circuitry 136, 138, 140 for each of the respective antenna elements 110-1 14.

In one embodiment, as shown in FIG. 8, the tag 100 is an active tag arranged to comprise its own power supply 142 to provide power to the processing circuitry 102. In another embodiment, the tag is a passive tag arranged to use one or more of the antenna elements 110-114 to generate power for the processing circuitry 102.

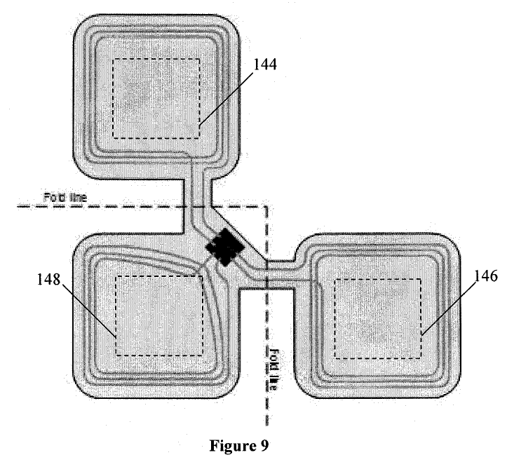

As shown in FIG. 9, in one embodiment, the tag 100 comprises attachment elements 144, 146, 148 (including adhesives) to allow it to be permanently or removably attached to the article 50.

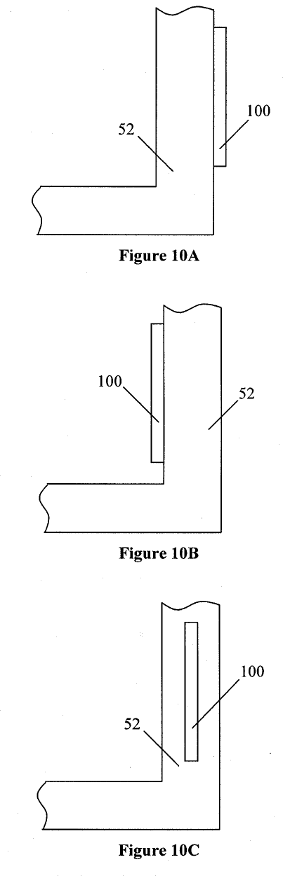

As shown in FIG. 10A, in one embodiment, the tag 100 is arranged to be attached to an exterior part of a wall 52 of the article 50. In another embodiment, as shown in FIG. 10B, the tag 100 is arranged to be attached to an interior part of the wall 52 of the article 50. In another embodiment, as shown in FIG. 10C, the tag 100 is arranged to be integrated within the wall 52 of the article 50. Using the tag 100 of FIG. 4, the tag 100 would be placed around a corner 68 of the article 50 so that the respective tag elements lie in different planes.

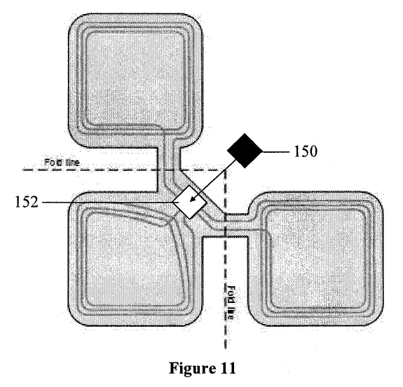

In the embodiment shown in FIG. 4, the processing circuitry 102 is integrated with the tag 100. In the embodiment shown in FIG. 11, the processing circuitry 150 is attachable to the antenna elements 110-114 via a socket 152 to operatively form the tag 100.

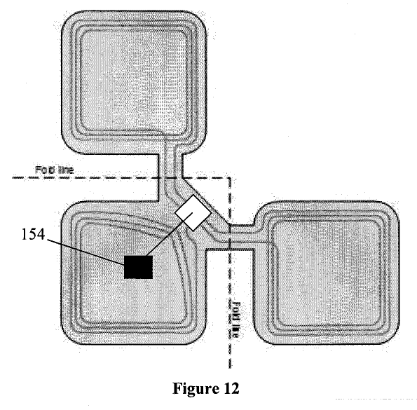

In the embodiment shown in FIG. 12, the processing circuitry 154 is located on one of the wings 104-108 of the tag 100.

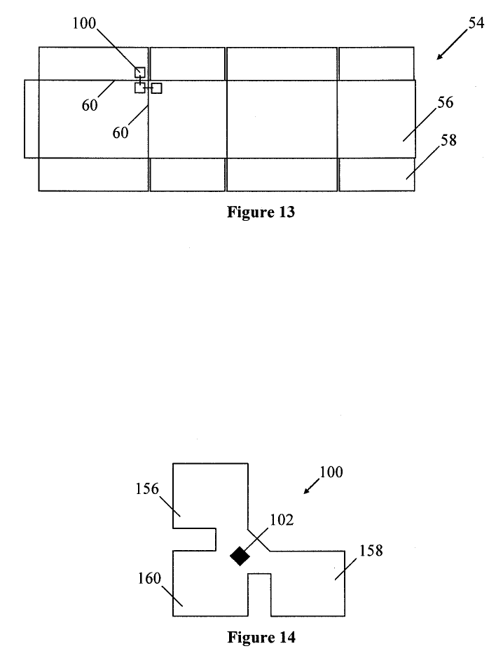

FIG. 13 shows an article blank 54 to be formed into the article 50, the blank 54 comprising portions, for example those designated by the numerals 56, 58, which are foldable with respect to one another to form walls of the article 50. When the article 50 is formed, the walls lie in substantially different planes. Certain walls comprise antenna elements to form a tag 100. The blank 54 comprises fold/crease lines, for example those designated by the numeral 60, to allow the portions 56, 58 to be folded with respect to one another. The fold/crease lines 116, 118 of the tag 100 are co-incident with the fold/crease lines 60 of the blank 54 to allow the respective antenna elements to be folded with the portions 56, 58. Depending on how the blank 54 is folded, the tag 100 may end up being positioned on an interior or exterior wall (or internal to a wall) of the formed article 50.

In one embodiment, as shown in FIG. 14, one or more of the tag antenna elements 110-114 are omnidirectional antenna elements 156, 158, 160.

In use, when the article 50 containing the tag 100 is in proximity of the reader 20, the antenna elements 110-114 (coils) that are aligned so as to be facing the reader receive the most energy. There may be a situation in which all the coils receive the same energy (when the reader 20 is located diagonally to the article 50).

By measuring the field strength through each coil, the direction of the reader 20 can be measured. This can be utilized to check that the article 50 is oriented in a correct way.

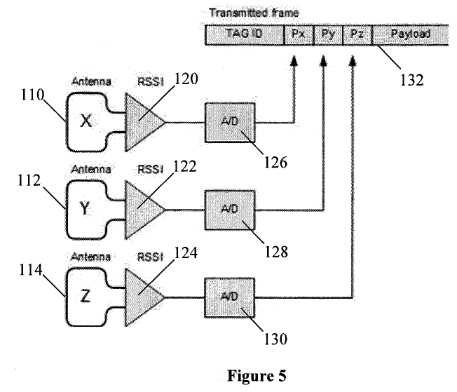

FIG. 5 illustrates an application of the tag 100. The field strength of each coil is measured by a respective Radio Signal Strength Indicator (RSSI) unit 120, 122, 124 and converted to digital form by an analogue-to-digital converter 126, 128, 130. The results are stored to a frame 132, which is sent to the reader 20. The reader 20 is arranged to determine the orientation from the relative field strengths. The reader 20 is arranged to take into account attenuation due to the article 50.

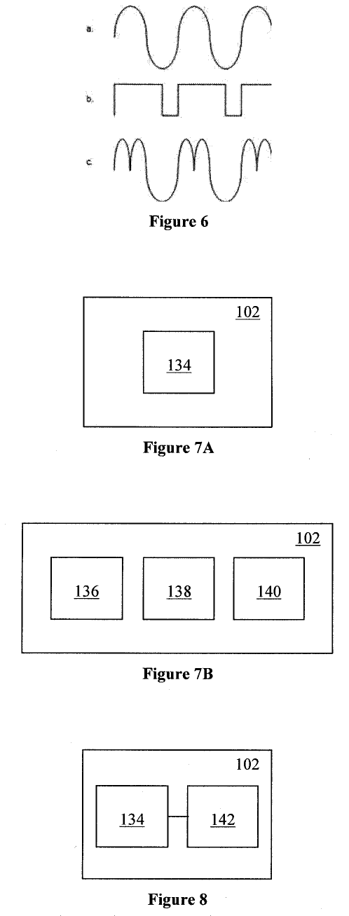

In one embodiment, the tag coils do not recognize polarity (the RF energy is in form of sinusoidal field), such that, if the article 50 is rotated or flipped 180 degrees over any axis or all axes, the readings would be the same. Thus it is not possible to detect whether or not the article 50 is upside down, for example. In another embodiment, the RF energy is modified in such a way that the tag 100 can tell the polarity of the RF energy. In addition, the reader 20 is arranged to detect the orientation of the article 50. The RF energy is in the form of an asymmetrical waveform. FIG. 6 shows some example cases. A square wave that has non-fifty-fifty mark-space ratio is one example, as shown in trace (b). Another example is to make the sine wave halves different (i.e. the upper half consists of two waves that have half the cycle time), as shown in trace (c). In another embodiment, a smart algorithm is used (to compare the attenuation of the energy).

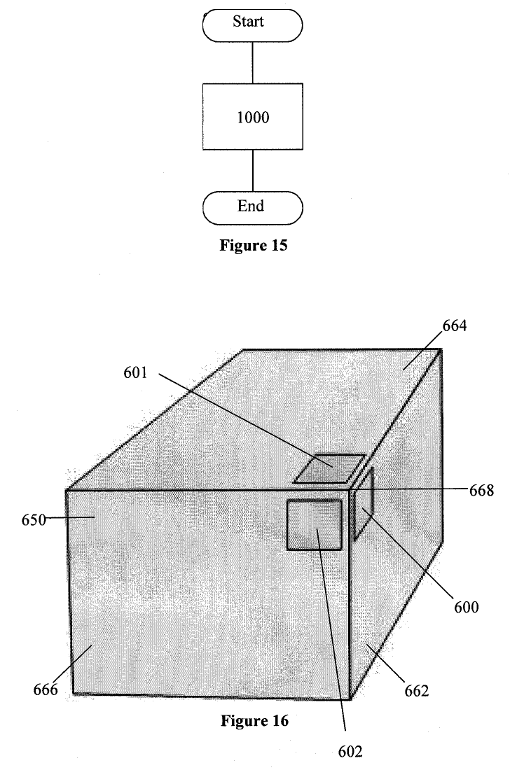

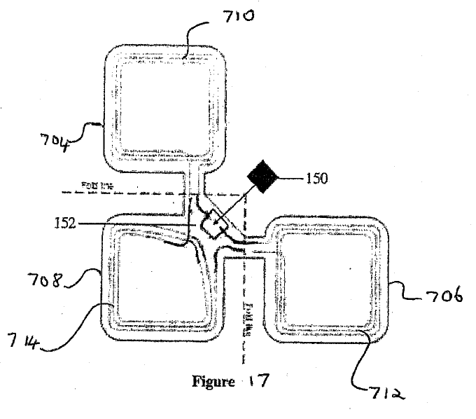

FIG. 15 is a flowchart representing a method of determining the orientation of a radio frequency identification tag. The method includes the step (1000) of measuring the relative field strength of signals received from respective antenna elements of the tag 100, the antenna elements lying in different planes. The antenna elements may be different parts of the same antenna (e.g. FIG. 17).

FIG. 16 shows a further embodiment of the present invention in which three independent tags 600, 601, 602 are placed on different faces 662, 664, 666 (and therefore located in different planes) around the corner 668 of an article 650. The tags 600, 601, 602 may be formed on tape which can be dispensed/applied onto a blank such that when the blank is configured into the article, the tags are positioned in differing planes (e.g. as in FIG. 16).

FIG. 17 shows a further embodiment of the invention in which the antenna elements which are configurable to lie in different planes are actually different parts of the same antenna element. As can be seen, the antenna elements 710, 712, 714 are each located on respective foldable wings 704, 706, 708 but they form a continuous single antenna rather than (three) separate antenna elements. A single processing circuitry 150 is used for the respective antenna elements 710, 712, 714.

The antenna elements may be printed e.g. using ink jet printing with a conductive ink. Other methods such as etched tape or hot wire implanting may be used to apply one or more antenna elements. Such processes allow the separate manufacture of the antenna elements to the processing circuitry. The processing circuitry used in such embodiments would be appropriate for such antenna elements and may be provided by a different manufacturer to the antenna element manufacturer.

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A radio frequency identification tag comprising first and second antenna elements, wherein the first and second antenna elements are configurable to be, in use, positioned to lie in substantially different planes.

2. The tag according to claim 1, wherein the tag is arranged such that the antenna elements are configurable to lie in substantially orthogonal planes.

3. The tag according to claim 1, wherein the tag is arranged to have a first non-use configuration in which the antenna elements are positioned to lie substantially in the same plane, and a second in-use configuration in which the antenna elements are positioned to lie in substantially different planes, and wherein the tag is arranged to be configurable between the first and second configurations.

4. The tag according to claim 3, wherein the tag comprises fold/crease lines to allow the antenna elements to be configured between one or more first and one or more second tag configurations.

5. The tag according to claim 3, wherein the tag comprises crease/fold lines configured to allow the antenna elements to be repeatedly folded between one or more first and one or more second tag configurations.

6. The tag according to claim 1, wherein the tag comprises a third antenna element configurable to be positioned to lie in a substantially different plane to the first and second antenna elements.

7. The tag according to claim 6, wherein the third antenna element is configurable to be positioned to lie in a plane substantially orthogonal to the first and second antenna elements.

8. The tag according to claim 6, wherein the third antenna element is configurable to be positioned to lie in a plane substantially orthogonal to the first and second antenna elements, the first and second antenna elements configurable to lie in substantially orthogonal planes with respect to one another.

9. The tag according to claim 1, wherein the tag is arranged to be configurable such that the respective antenna elements are positionable on different faces of the article to which the tag is to be attached, the faces lying in substantially different planes.

10. The tag according to claim 1, wherein the tag is arranged to be configurable such that the respective antenna elements are positionable around a corner of the article to which the tag is to be attached.

11. The tag according to claim 1, wherein the tag comprises foldable wings, and wherein the first and second antenna elements are each arranged to be located with a respective foldable wing.

12. The tag according to claim 1, wherein the tag is comprises a body and foldable wings, the body comprising processing circuitry for one or more of the antenna elements, and wherein the first and second antenna elements are each arranged to be located with a respective foldable wing.

13. The tag according to claim 1, wherein the tag is arranged to comprise processing circuitry for each of the respective antenna elements.

14. The tag according to claim 1, wherein the tag is arranged to comprise common processing circuitry for at least the first and second the antenna elements.

15. The tag according to claim 1, wherein the tag is an active tag arranged to comprise its own power supply to provide power to tag processing circuitry.

16. The tag according to claim 1, wherein the tag is a passive tag arranged to use one or more of the antenna elements to generate power for tag processing circuitry.

17. The tag according to claim 1, wherein the tag is arranged such that the respective antenna elements can move with respect to one another as the respective faces of the article to which they are attached move with respect to one another.

18. The tag according to claim 1, wherein one or more of the tag antenna elements is an omnidirectional antenna element.

19. The tag according to claim 1, wherein the tag is configured in a first non-use configuration.

20. The tag according to claim 1, wherein the tag is configured in a second in-use configuration.

21. A radio frequency identification tag comprising first and second antenna elements, wherein the first and second antenna elements are positioned to lie in substantially different planes.

22. The tag according to claim 21, wherein the tag is arranged such that the antenna elements are configured to lie in substantially orthogonal planes.

23. The tag according to claim 21, wherein the tag comprises a third antenna element configured to be positioned to lie in a substantially different plane to the first and second antenna elements.

24. The tag according to claim 23, wherein the third antenna element is configured to be positioned to lie in a plane substantially orthogonal to the first and second antenna elements.

25. The tag according to claim 23, wherein the third antenna element is configured to be positioned to lie in a plane substantially orthogonal to the first and second antenna elements, the first and second antenna elements being configured to lie in substantially orthogonal planes with respect to one another.

26. The tag according to claim 21, wherein the tag comprises a body and wings, the body comprising processing circuitry for one or more of the antenna elements, and wherein the first and second antenna elements are each arranged to be located with a respective wing.

27. An article to which a radio frequency identification tag is attached, the tag comprising antenna elements attached to lie in substantially different planes of the article.

28. An article to which is attached respective radio frequency identification tags located on two or more faces of the article, the faces lying in substantially different planes.

29. An article comprising a radio frequency identification tag integrated within respective walls of the article, the tag comprising antenna elements arranged to lie in substantially different planes.

30. An article blank to be formed into an article, the blank comprising portions foldable with respect to one another to form walls of the article which, when the article is formed, lie in substantially different planes, and wherein respective walls comprise antenna elements for one or more radio frequency identification tags.

31. A blank according to claim 30, wherein the blank is arranged such that the blank comprises crease/fold lines to allow the portions to be folded with respect to one another, the antenna elements forming part of a single radio frequency identification tag.

32. A blank according to claim 31, wherein the single radio frequency identification tag comprises crease/fold lines co-incident with the crease/fold lines of the blank to allow the respective antenna elements to be folded with the portions to form the walls of the article.

33. A method of determining the orientation of a radio frequency identification tag by measuring the relative field strength of signals received from respective antenna elements lying in different planes.

34. An antenna for an RFID tag having configurable parts that can be positioned to lie in substantially different planes.
